(19) United States
(12) Patent Application Publication
(10) Pub. No.: US 2024/0357363 A1
(43) Pub. Date: Oct. 24, 2024

(54) COORDINATED SPATIAL REUSE AND FREQUENCY UTILIZATION IN OVERLAPPING BASIC SERVICE SET ENVIRONMENTS

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR)

(73) Assignee: NEWRACOM, Inc., Irvine, CA (US)

(21) Appl. No.: 18/629,570

(22) Filed: Apr. 8, 2024

Related U.S. Application Data
(60) Provisional application No. 63/497,180, filed on Apr. 19, 2023.

(51) Int. Cl. H04W 16/02; H04W 52/36

(52) U.S. Cl. CPC H04W 16/02; H04W 52/367

(57) ABSTRACT

Coordinated spatial reuse and frequency utilization techniques in overlapping basic service set environments for IEEE 802.11be and beyond. The techniques involve transmit power and frequency allocation methods designed for coordinated spatial reuse between multiple access points, considering interference from stations and access points, as well as occupied bandwidth. In one embodiment, an access point generates a trigger frame with punctured bandwidth or good subchannel information to coordinate spatial reuse, enabling a station to transmit an uplink data packet using specified parameters. In another embodiment, a station receives a trigger frame with punctured bandwidth information and transmits an uplink data packet excluding the puncture portion to avoid interference. The techniques allow transmissions in multiple basic service sets to coexist without harmful interference, improving throughput and frequency utilization in dense wireless networks. Although primarily described in the context of IEEE 802.11, the techniques can be applied to other wireless networks.

### CROSS-REFERENCE TO RELATED APPLICATION

This application claims the benefit of U.S. Provisional Application No. 63/497,180 filed Apr. 19, 2023, which is hereby incorporated by reference.

### TECHNICAL FIELD

The present disclosure generally relates to wireless communications, and more specifically, relates to coordinated spatial reuse and frequency utilization in overlapping basic service set environments.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The 802.11 family of standards has evolved over time to accommodate higher data rates, improved security, and better performance in different environments. Some of the most widely used standards include 802.11a, 802.11b, 802.11g, 802.11n, 802.11ac, and the latest 802.11ax (also known as “Wi-Fi 6”). These standards specify the modulation techniques, channel bandwidths, and other technical aspects that ensure interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

IEEE 802.11be proposes a set of spatial reuse techniques designed to improve the efficiency and capacity of wireless networks by allowing multiple devices to communicate simultaneously in the same physical space. This is achieved through advanced channel access and interference management mechanisms.

One key aspect of 802.11be's spatial reuse scheme is the enhanced use of multi-user multiple-input, multiple-output (MU-MIMO) technology, which enables access points to communicate with multiple devices simultaneously using different spatial streams. This allows for more efficient use of the available spectrum and reduces the impact of interference.

Additionally, 802.11be introduces a technique called coordinated spatial reuse, which enables access points to collaborate and coordinate their transmissions to minimize interference and maximize spatial reuse. Coordinated spatial reuse allows access points to exchange information about their transmission schedules, power levels, and channel usage, enabling them to dynamically adjust their parameters to optimize network performance.

Furthermore, 802.11be's spatial reuse scheme includes advanced channel access mechanisms, such as improved clear channel assessment (CCA) and enhanced distributed channel access (EDCA), which help devices better assess the availability of channels and prioritize traffic based on quality of service (QOS) requirements.

However, the current spatial reuse schemes still have limitations to increase the efficiency in spectral utilization.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network with a basic service set that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates inter-frame space relationships, in accordance with some embodiments of the present disclosure.

FIG. 5 illustrates a carrier sense multiple access/collision avoidance-based frame transmission procedure, in accordance with some embodiments of the present disclosure.

FIG. 6 is a table of various characteristics of several wireless networking standards, in accordance with some embodiments of the present disclosure.

FIG. 7 is a table of various fields of an extremely high throughput physical protocol data unit frame, in accordance with some embodiments of the present disclosure.

FIG. 8 illustrates an example of parameterized spatial reuse operation in an overlapping basic service set network, in accordance with some embodiments of the present disclosure.

FIG. 9 illustrates an example of spatial reuse with preamble-punctured transmissions, in accordance with some embodiments of the present disclosure.

FIG. 10 illustrates an example of spatial reuse with punctured resource unit transmissions, in accordance with some embodiments of the present disclosure.

FIG. 11 illustrates an example of spatial reuse-trigger frame-based spatial reuse transmissions, in accordance with some embodiments of the present disclosure.

FIG. 12 is a flowchart of a method for coordinated spatial reuse and frequency utilization in an overlapping basic service set environment at a wireless device functioning as an access point in a basic service set, in accordance with some embodiments of the present disclosure.

FIG. 13 is a flowchart of a method for coordinated spatial reuse and frequency utilization in an overlapping basic service set environment at a wireless device functioning as an access point in an overlapping basic service set that overlaps a basic service set, in accordance with some embodiments of the present disclosure.

FIG. 14 is a flowchart of a method for coordinated spatial reuse and frequency utilization in an overlapping basic service set environment at a wireless device functioning as a station in a basic service set, in accordance with some embodiments of the present disclosure.

FIG. 15 is a flowchart of a method for coordinated spatial reuse and frequency utilization in an overlapping basic service set environment at a wireless device functioning as a station in an overlapping basic service set that overlaps a basic service set, in accordance with some embodiments of the present disclosure.

### DETAILED DESCRIPTION

The present disclosure generally relates to wireless communications, and more specifically, relates to coordinated spatial reuse and frequency utilization in overlapping basic service set environments.

In the context of the Institute of Electrical and Electronics Engineers (IEEE) 802.11be standard and beyond, which aims to enhance wireless network performance beyond the capabilities of its predecessors, the issue of coordination between multiple access points is addressed. The conventional spatial reuse technique focuses on mitigating interference from stations in overlapping basic service sets. However, it is important to consider the interference caused by the access points of overlapping basic service sets as well. Moreover, the occupied bandwidth, including subchannels and resource units, should be considered when determining the transmit power and allocation of subchannels and resource units to optimize network performance.

To tackle the aforementioned problem and improve throughput while achieving efficient frequency utilization, embodiments disclosed herein involve transmit power and frequency allocation techniques specifically designed for coordinated spatial reuse between multiple access points. By implementing these techniques, access points can collaborate and coordinate their transmissions, considering the interference from both stations and other access points in the overlapping basic service set. Additionally, embodiments consider the occupied bandwidth, such as subchannels and resource units, when determining the optimal transmit power and allocation of these resources to each access point and its associated stations.

A benefit of the disclosed transmit power and frequency allocation techniques for coordinated spatial reuse between multiple access points is the ability for transmissions in multiple basic service sets (BSSs) to coexist without causing harmful interference to one another. By carefully coordinating the transmit power and frequency allocation based on the interference from stations and access points in the overlapping basic service set, as well as considering the occupied bandwidth, the network can achieve improved throughput and more efficient utilization of the available frequency resources. This ultimately leads to enhanced performance and a better user experience in dense, high-traffic wireless network environments.

An embodiment of the techniques is a method for improving throughput and achieving efficient frequency utilization through coordinated spatial reuse between multiple access points (access points) in overlapping basic service sets. In this embodiment, a wireless device functioning as an access point in a basic service set generates a trigger frame to initiate an uplink data transmission from a station within its basic service set. The trigger frame includes information for coordinating spatial reuse in an overlapping basic service set that overlaps with the basic service set. This information can be in the form of punctured bandwidth information, indicating which portions of the bandwidth are unavailable due to interference, or good subchannel information, specifying the subchannels that are suitable for transmission. By incorporating this information into the trigger frame, the access point effectively communicates the optimal transmission parameters to the station, considering the interference from other access points and stations in the overlapping basic service set. Upon wirelessly transmitting the trigger frame, the station can initiate its uplink data transmission using the specified parameters, ensuring that its transmission coexists with other ongoing transmissions in the overlapping basic service set without causing harmful interference.

In another embodiment of the techniques, a wireless device functioning as a station in a basic service set receives a trigger frame from its associated access point. The trigger frame contains punctured bandwidth information, which is useful for coordinating spatial reuse in an overlapping basic service set that overlaps with the basic service set. The punctured bandwidth information identifies a specific portion of the bandwidth channel that is considered a “puncture portion,” indicating that it is affected by interference and should be avoided during transmission. Upon receiving the trigger frame, the station prepares to wirelessly transmit an uplink data packet to the access point. To ensure effective coordination of spatial reuse, the station transmits the uplink data packet using the punctured bandwidth channel while excluding at least a portion of the data packet from being transmitted through the identified puncture portion. By avoiding the use of the puncture portion, which is known to be impacted by interference from other access points or stations in the overlapping basic service set, the station's uplink transmission can coexist with other ongoing transmissions without causing harmful interference.

For sake of illustration, various embodiments are primarily described herein in the context of wireless networks based on Institute of Electrical and Electronics Engineers (IEEE) 802.11 standards using terminology thereof. However, embodiments are not limited thereto. Those skilled in the relevant art will appreciate that the techniques disclosed herein can be used in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

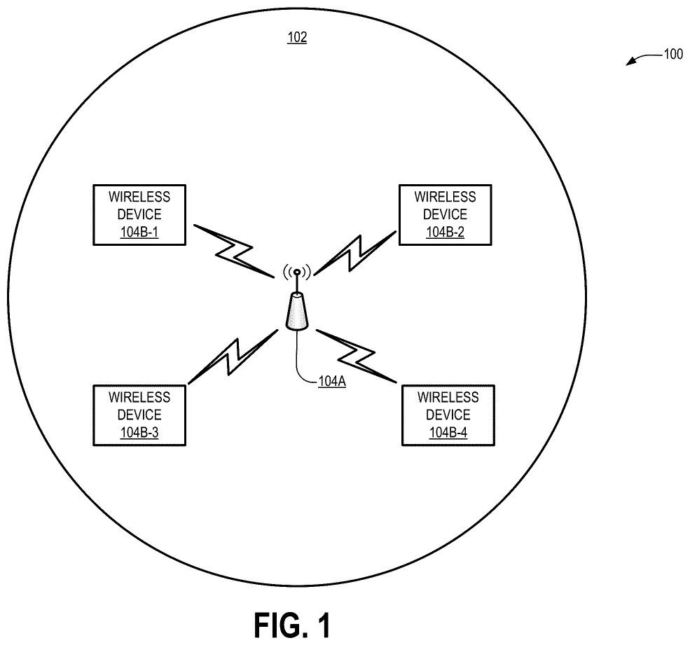

FIG. 1 depicts a wireless local area network 100 (WLAN 100) with a basic service set (BSS) 102. The BSS 102 comprises multiple wireless devices 104 (also known as WLAN devices 104). Each wireless device 104 is equipped with a medium access control (MAC) layer and a physical (PHY) layer, conforming to the IEEE 802.11 standard, which may include any of its amendments (e.g., 802.11a/b/g/n/p/ac/ax/bd/be).

In one embodiment, the medium access control (MAC) layer of a wireless device 104 can initiate the transmission of a frame to another wireless device 104 by passing a PHY-TXSTART.request (TXVECTOR) to the physical (PHY) layer. The TXVECTOR specifies parameters for generating and/or transmitting the corresponding frame. Likewise, the PHY layer of a receiving wireless device can generate an RXVECTOR, which includes parameters of the received frame, and pass it to the MAC layer for processing.

The group of wireless devices 104 may include a wireless device 104A that serves as an access point, sometimes referred to as an “access point station” or “AP STA,” and other wireless devices 104B1-104B4 that function as non-access point stations, often called “non-AP STAs.”

Alternatively, in an ad-hoc networking environment, all devices in the group, 104, might be non-access point stations. Typically, both the access point station (e.g., wireless device 104A) and the non-access point stations (e.g., wireless devices 104B1-104B4) are collectively considered stations. However, for simplicity in this description, the term stations may sometimes only refer to non-access point stations. While this example shows four non-access point stations (wireless devices 104B1-104B4), the wireless local area network (WLAN) 100 can accommodate any number of non-access point stations (e.g., one or more wireless devices 104B).

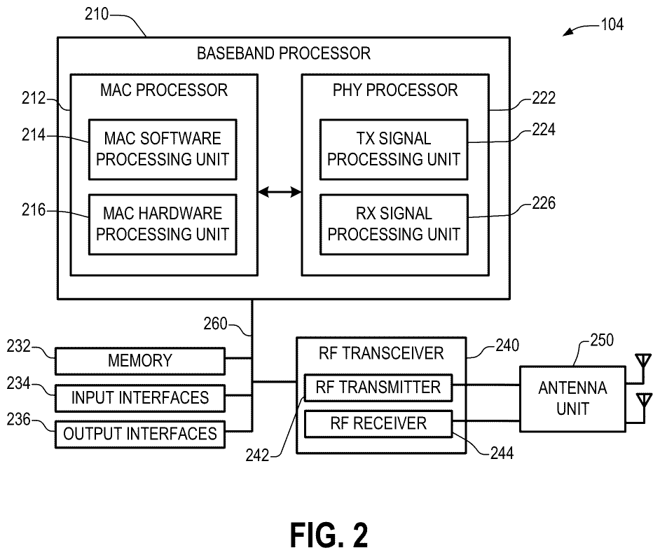

FIG. 2 presents a schematic block diagram of a wireless device 104, according to an embodiment. This wireless device 104 could be either the wireless device 104A (e.g., the access point of wireless local area network (WLAN) 100) or any of the wireless devices 104B1-104B4 depicted in FIG. 1. The wireless device 104 comprises a baseband processor 210, a radio frequency (RF) transceiver 240 (RF transceiver 240), an antenna unit 250, a storage device (e.g., memory) 232, one or more input interfaces 234, and one or more output interfaces (236). The baseband processor 210, the storage device 232, the input interfaces 234, the output interfaces (236), and the RF transceiver 240 are interconnected via a bus 260.

The baseband processor 210 is responsible for baseband signal processing and encompasses a medium access control (MAC) processor 212 (MAC processor 212) and a physical (PHY) processor 222 (PHY processor 222). It may access memory 232, which can be a non-transitory computer-readable medium containing software (e.g., programming instructions) and data.

In an embodiment, the MAC processor 212 comprises a MAC software processing unit 214 and a MAC hardware processing unit 216. The MAC software processing unit 214 executes MAC software to perform a first set of functions of the MAC layer, which can be part of the software stored in storage device 232. Conversely, the MAC hardware processing unit 216 realizes a second set of MAC layer functions through specialized hardware. However, the configuration of the MAC processor 212 is not limited to these arrangements. For instance, it may be designed to execute both sets of functions entirely in software or hardware, depending on the specific implementation.

The PHY processor 222 comprises a transmitting (TX) signal processing unit (SPU) 224 (TxSPU 224) and a receiving (RX) SPU 226 (RxSPU 226). It executes a variety of functions associated with the physical (PHY) layer, which can be carried out in software, hardware, or a mix of both, depending on the implementation.

Functions performed by the TxSPU 224 may include, but are not limited to, forward error correction (FEC) encoding, parsing streams into one or more spatial streams, diversity encoding of these spatial streams into a multitude of space-time streams, spatial mapping of space-time streams to transmit chains, inverse Fourier transform computation, and cyclic prefix insertion to establish a guard interval. Conversely, the RxSPU 226 may handle functions that are essentially the inverses of those performed by the TxSPU 224, such as guard interval removal, Fourier transform computation, among others.

The radio frequency (RF) transceiver 240 (RF transceiver 240) comprises an RF transmitter 242 and an RF receiver 244. It is designed to transmit information (referred to as first information) received from the baseband processor 210 to the wireless local area network (WLAN) 100 (for example, to another wireless device 104 within the WLAN 100) and to relay information (referred to as second information) received from the WLAN 100 (for example, from another wireless device 104 of the WLAN 100) back to the baseband processor 210.

The antenna unit 250 comprises one or more antennas. For applications utilizing multiple-input, multiple-output (MIMO) or multi-user multiple-input, multiple-output (MU-MIMO), the antenna unit 250 may feature a plurality of antennas. In certain embodiments, these antennas can function as part of a beamforming array. Additionally, the antennas within the antenna unit 250 can be either directional, with options for fixed or steerable orientations.

Input interfaces 234 receive information from a user, while the output interfaces 236 convey information to the user. The input interfaces 234 may consist of one or more of the following: a keyboard, keypad, mouse, touchscreen, microphone, among others. Similarly, the output interfaces 236 may include one or more of the following: a display device, touchscreen, speaker, among others.

As outlined in this document, numerous functions of the wireless local area network (WLAN) device 104 can be realized through either hardware or software. The decision to implement certain functions in software and others in hardware is influenced by various design constraints. These constraints may encompass aspects such as design and manufacturing costs, time-to-market objectives, power consumption considerations, and the availability of semiconductor technology, among others.

As described herein, a wide variety of electronic devices, circuits, firmware, software, and combinations thereof may be used to implement the functions of the components of the wireless local area network (WLAN) device 104. Furthermore, the WLAN device 104 may include other components, such as application processors, storage interfaces, clock generator circuits, power supply circuits, and the like, which have been omitted in the interest of brevity.

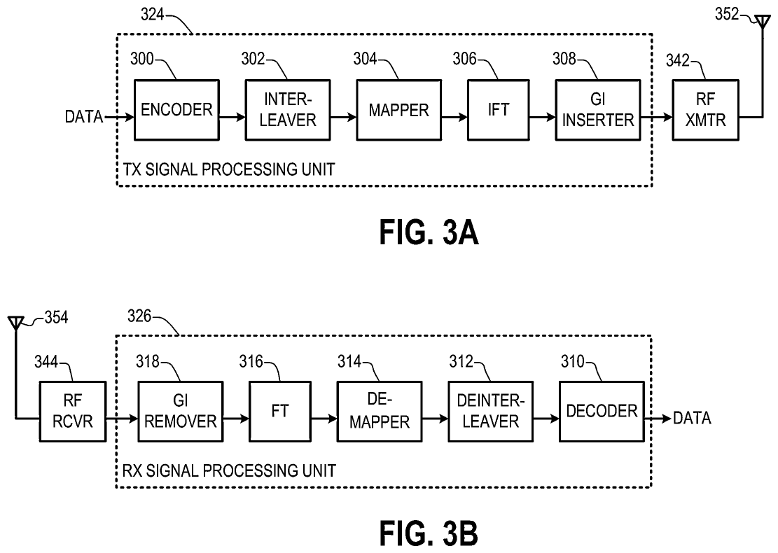

FIG. 3A illustrates components of a wireless local area network (WLAN) device 104 configured to transmit data according to an embodiment, including a transmitting (TX) signal processing unit (SPU) 324 (TxSPU 324), a radio frequency (RF) transmitter 342 (RF transmitter 342), and an antenna 352. In an embodiment, the TxSPU 324, the RF transmitter 342, and the antenna 352 correspond to the TxSPU 224, the RF transmitter 242, and an antenna of the antenna unit 250 of FIG. 2, respectively.

The TxSPU 324 comprises an encoder 300, an interleaver 302, a mapper 304, an inverse Fourier transformer 306, and a guard interval inserter 308.

Encoder 300 receives input data and encodes it. In one embodiment, the encoder 300 features a forward error correction (FEC) encoder, which may consist of a binary convolutional code encoder followed by a puncturing device. Alternatively, the FEC encoder may utilize a low-density parity-check encoder.

The TxSP 324 may also incorporate a scrambler to scramble the input data before encoding by the encoder 300, aiming to minimize the likelihood of prolonged sequences of 0s or 1s. When binary convolutional code encoding is executed by the encoder 300, the TxSP 324 might include an encoder parser to demultiplex the scrambled bits across multiple binary convolutional code encoders. However, if the encoder utilizes low-density parity-check encoding, the TxSP 324 may forego the use of the encoder parser.

The interleaver 302 interleaves the bits of each stream output from the encoder 300, altering their order. The interleaver 302 applies interleaving specifically when the encoder 300 performs binary convolutional code encoding. In cases where binary convolutional code encoding is not used, it may pass the stream output from the encoder 300 without modifying the bit order.

Mapper 304 converts the sequence of bits output from the interleaver 302 into constellation points. When the encoder 300 uses low-density parity-check encoding, the mapper 304 may additionally execute low-density parity-check tone mapping, alongside constellation mapping.

When the TxSP 324 is engaged in multiple-input, multiple-output (MIMO) or multi-user multiple-input, multiple-output (MU-MIMO) transmissions, it may incorporate multiple interleavers 302 and mappers 304, corresponding to the number of spatial streams involved in the transmission. Additionally, the TxSP 324 might feature a stream parser to segment the encoder 300's output into blocks, which are then distributed to different interleavers 302 or mappers 304. It may also include a space-time block code encoder to disperse the constellation points across the spatial streams into a set number of space-time streams, and a spatial mapper tasked with assigning these space-time streams to transmit chains. This spatial mapper could employ strategies such as direct mapping, spatial expansion, or beamforming for optimal transmission.

The inverse Fourier transform 306 transforms a block of constellation points, received from the mapper 304 or, in cases of multiple-input, multiple-output (MIMO) or multi-user multiple-input, multiple-output (MU-MIMO), the spatial mapper, into a time domain block (e.g., a symbol) through an inverse discrete Fourier transform or an inverse fast Fourier transform. When employing the space-time block code encoder and the spatial mapper, a dedicated inverse Fourier transform 306 may be provided for each transmit chain.

When conducting a multiple-input, multiple-output (MIMO) or multi-user multiple-input, multiple-output (MU-MIMO) transmission, the TxSP 324 may incorporate cyclic shift diversities to avert unintended beamforming. The cyclic shift diversities insertion can occur cither before or after the inverse Fourier transform 306 process. It can be applied specifically for each transmit chain or for each space-time stream. Alternatively, cyclic shift diversities may be integrated as part of the spatial mapping process.

In multiple-input, multiple-output (MIMO) or multi-user multiple-input, multiple-output (MU-MIMO) transmissions conducted by the TxSP 324, specific blocks preceding the spatial mapper are allocated individually for each user.

The guard interval inserter 308 appends a guard interval to the beginning of each symbol output by the inverse Fourier transform 306. This guard interval typically comprises a cyclic prefix, which is a duplicate of the symbol's concluding segment, placed before the symbol to mitigate interference. Optionally, the TxSP 324 can apply windowing to each symbol post-guard interval insertion to smooth out the symbol edges.

The RF transmitter 342 converts the baseband symbols into a radio frequency (RF) signal and then transmits this RF signal through antenna 352. In cases where the TxSP 324 supports multiple-input, multiple-output (MIMO) or multi-user multiple-input, multiple-output (MU-MIMO) transmissions, both the guard interval inserter 308 and the RF transmitter 342 are configured for each individual transmit chain.

FIG. 3B illustrates components of a wireless local area network (WLAN) device 104 configured to receive data, including a receiver signal processing unit 326 (RxSPU 326), a radio frequency (RF) receiver 344 (RF receivers 344), and an antenna 354. In this embodiment, the RxSPU 326, RF receiver 344, and antenna 354 correspond to the receiving SPU 226, the RF receiver 244, and one of the antennas in the antenna unit 250 of FIG. 2, respectively.

The RxSPU 326 includes a guard interval remover 318, a Fourier transformer 316 (FT 316), a demapper 314, a deinterleaver 312, and a decoder 310.

The RF receiver 344 receives a radio frequency (RF) signal via the antenna 354 and converts the RF signal into symbols. The guard interval remover 318 then removes the guard interval from each symbol. When the received transmission employs multiple-input, multiple-output (MIMO) or multi-user multiple-input, multiple-output (MU-MIMO) technology, the RF receiver 344 and the guard interval remover 318 may be allocated for each receive chain.

The FT 316 converts each symbol (e.g., each time domain block) into a frequency domain block of constellation points using either a discrete Fourier transform (DFT) or a fast Fourier transform (FFT). FT 316 may be allocated for each receive chain.

When the received transmission is a multiple-input, multiple-output (MIMO) or multi-user multiple-input, multiple-output (MU-MIMO) transmission, the RxSP 326 may include a spatial demapper that converts the outputs of the FTs 316 from the receiver chains into constellation points of multiple space-time streams. Additionally, a space-time block code decoder may be employed for despreading the constellation points from the space-time streams into one or more spatial streams.

The demapper 314 demaps the constellation points output from the FT 316 or the space-time block code decoder to bit streams. If the received transmission was encoded using low-density parity-check encoding, demapper 314 may further perform low-density parity-check tone demapping before performing the constellation demapping.

The deinterleaver 312 deinterleaves the bits of each stream output from the demapper 314. It performs deinterleaving specifically when the received transmission was encoded with binary convolutional code encoding. Otherwise, it may pass the stream from demapper 314 without any deinterleaving.

When the received transmission employs multiple-input, multiple-output (MIMO) or multi-user multiple-input, multiple-output (MU-MIMO) technology, the RxSP 326 may incorporate multiple demappers 314 and deinterleavers 312, matching the number of spatial streams in the transmission. In such scenarios, the RxSP 326 may also include a stream deparser for aggregating the outputs from the deinterleavers 312.

The decoder 310 processes the streams emanating from either deinterleaver 312 or the stream deparser. In a specific embodiment, the decoder 310 is equipped with a forward error correction (FEC) decoder. This FEC decoder can be configured as either a binary convolutional code decoder or a low-density parity-check decoder.

The RxSP 326 might also incorporate a descrambler to revert the decoding process on the decoded data. If binary convolutional code decoding is executed by decoder 310, the RxSP 326 could additionally employ an encoder deparser for aggregating the data decoded by multiple binary convolutional code decoders. Conversely, if low-density parity-check decoding is carried out by decoder 310, the use of the encoder deparser may not be necessary.

Before initiating a transmission, wireless devices, including wireless device 104, assess the availability of the wireless medium through clear channel assessment (CCA). CCA determines the medium as busy if it is occupied, and idle if it is available.

The physical (PHY) entity of Institute of Electrical and Electronics Engineers (IEEE) 802.11 is based on Orthogonal Frequency Division Multiplexing (OFDM) or Orthogonal Frequency Division Multiple Access (OFDMA). In both OFDM and OFDMA Physical (PHY) layers, a station, such as wireless device 104, can transmit and receive PHY Protocol Data Units (PPDUs) in accordance with the mandatory PHY specifications. These specifications define a set of Modulation and Coding Schemes (MCS) and the maximum number of spatial streams. Certain PHY entities also specify downlink (DL) and uplink (UL) Multi-User (MU) transmissions, detailing a maximum number of space-time streams (STS) per user and a total number of STSs. PHY entities may support channel widths of 10 MHZ, 20 MHz, 40 MHZ, 80 MHz, 160 MHz, 240 MHz, and 320 MHz for contiguous channels, as well as 80+80, 80+160 MHz, and 160+160 MHz for non-contiguous channels. Each channel comprises multiple subcarriers, also known as tones. PHY entities define signaling fields within a PPDU, such as Legacy Signal (L-SIG), Signal A (SIG-A), and Signal B (SIG-B), to communicate essential information about PHY Service Data Unit (PSDU) attributes. For clarity and conciseness, the descriptions that follow will focus on OFDM-based 802.11 technology, referring to a station as a non-access point station unless specified otherwise.

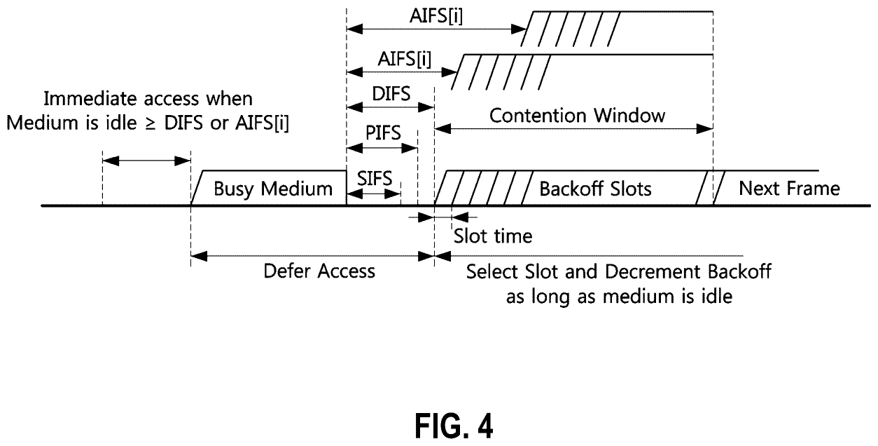

FIG. 4 illustrates the relationships among Inter-Frame Spaces (IFSs), showcasing a Short IFS (SIFS), a Point Coordination Function IFS (PIFS), a Distributed Coordination Function IFS (DIFS), and an Arbitration IFS (AIFS) for Access Category ‘i’ (AIFS[i]). Additionally, the figure depicts a slot time and the transmission of a data frame, which is forwarded to a higher layer for processing. As illustrated, a wireless local area network (WLAN) device 104 initiates the transmission of the data frame following a backoff period, provided that a DIFS duration has passed with the medium remaining idle.

Management frames are utilized to exchange management information, which is not forwarded to higher layers. The subtypes of management frames include beacon frames, association request/response frames, probe request/response frames, and authentication request/response frames.

Control frames are employed to manage access to the medium. The subtypes of control frames encompass Request to Send (RTS), Clear to Send (CTS), and Acknowledgement (ACK) frames.

When the control frame does not serve as a response to another frame, wireless local area network (WLAN) device 104 transmits the control frame after initiating a backoff procedure, provided a DIFS (Distributed Coordination Function Inter-Frame Space) period has passed with the medium being idle. Conversely, if the control frame is a response to another frame, WLAN device 104 transmits the control frame following a SIFS (Short Inter-Frame Space) period, without performing a backoff or assessing the medium's idle status.

A wireless local area network (WLAN) device 104 equipped with quality of service (QoS) capabilities (sometimes referred to as a “QoS STA”) may initiate frame transmission after a backoff period, provided that the Arbitration Inter-Frame Space (AIFS) corresponding to the access category (AC) associated with the frame (i.e., AIFS[AC]) has elapsed. For transmissions by a QOS STA, data frames, management frames, and control frames (excluding response frames) can utilize the AIFS[AC] designated for the AC of the frame being transmitted.

A wireless local area network (WLAN) device 104 may initiate a backoff procedure upon finding the medium occupied when it is prepared to transmit a frame. This procedure entails calculating a random backoff duration consisting of N backoff slots, with each slot corresponding to a predefined slot time and N representing an integer greater than or equal to zero. The selection of the backoff period is influenced by the size of the Contention Window (CW). Furthermore, the backoff duration can be adjusted based on the Access Category (AC) of the frame in question. The commencement of all backoff slots follows either a Distributed Coordination Function Inter-Frame Space (DIFS) or an Extended Inter-Frame Space (EIFS), during which the medium must be observed as idle for the entirety of the interval.

When the wireless local area network (WLAN) device 104 observes no activity on the medium for the length of a designated backoff slot, the backoff procedure mandates reducing the backoff time by one slot time. Should the WLAN device 104 find the medium occupied during a backoff slot, the backoff process is paused and resumes only after the medium is perceived as idle for a complete Distributed Coordination Function Inter-Frame Space (DIFS) or Extended Inter-Frame Space (EIFS) interval. The device is then authorized to initiate the transmission or retransmission of the frame once the backoff timer counts down to zero.

The backoff procedure functions such that when multiple wireless local area network (WLAN) devices 104 defer and initiate the backoff process, each device selects a backoff time through a random function. The device with the shortest backoff time gains priority in the contention, thereby minimizing the likelihood of a collision.

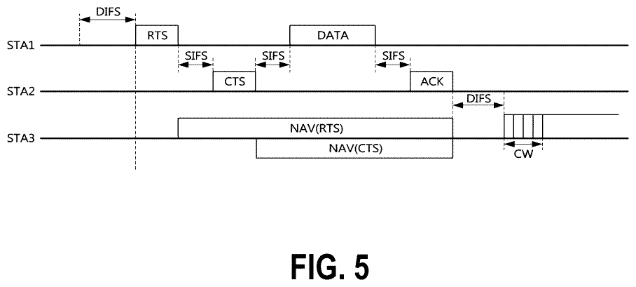

FIG. 5 illustrates a Carrier Sense Multiple Access with Collision Avoidance (CSMA/CA)-based frame transmission procedure designed to prevent collisions among frames on a channel, according to an embodiment. It depicts a first station (STA1) transmitting data, a second station (STA2) receiving the data, and a third station (STA3) situated in an area where it can receive a frame from either STA1, STA2, or both. Stations STA1, STA2, and STA3 may represent WLAN devices 104 as shown in FIG. 1.

The station STA1 may assess whether the channel is occupied by performing carrier sensing. It can determine the channel's status based on the energy level present in the channel, the autocorrelation of signals within the channel, or by utilizing a Network Allocation Vector (NAV) timer to ascertain channel occupation.

After determining that the channel is not occupied by other devices (i.e., the channel is IDLE) during a DIFS (and performing backoff, if required), the station STA1 may transmit a Request-To-Send (RTS) frame to station STA2. Upon receiving the RTS frame, after a SIFS, station STA2 may transmit a Clear-To-Send (CTS) frame in response. If Dual-CTS is enabled and station STA2 is an access point, the access point may issue two CTS frames in response to the RTS frame—for example, a first CTS frame in a non-High Throughput (non-HT) format and a second CTS frame in the High Throughput (HT) format.

When station STA3 receives the RTS frame, it may set its Network Allocation Vector (NAV) timer for the transmission duration of subsequently transmitted frames (for example, a duration of SIFS+CTS frame duration+SIFS+data frame duration+SIFS+ACK frame duration) using the duration information included in the RTS frame. If station STA3 receives the CTS frame, it may set its NAV timer for the transmission duration of subsequently transmitted frames based on the duration information included in the CTS frame. Upon receiving a new frame before the NAV timer expires, station STA3 may update its NAV timer using the duration information from the new frame. Station STA3 does not attempt to access the channel until its NAV timer expires.

When station STA1 receives the CTS frame from station STA2, it may transmit a data frame to station STA2 after a SIFS period elapses from the time when the CTS frame has been completely received. Upon successfully receiving the data frame, station STA2 may transmit an ACK frame in response to the data frame after a SIFS period elapses.

When the NAV timer expires, the third station STA3 may determine whether the channel is busy using carrier sensing. Upon determining that the channel is not occupied by other devices during a DIFS period after the NAV timer has expired, station STA3 may attempt to access the channel after a contention window elapses, according to a backoff process.

When Dual-CTS is enabled, a station that has obtained a transmission opportunity (TXOP) and that has no data to transmit may transmit a CF-End frame to cut short the TXOP. An access point receiving a CF-End frame with the Basic Service Set Identifier (BSSID) of the access point as the destination address may respond by transmitting two additional CF-End frames: the first CF-End frame using Space Time Block Coding (STBC) and the second CF-End frame using non-STBC. A station receiving a CF-End frame resets its NAV timer to 0 at the end of the PHY Protocol Data Unit (PPDU) containing the CF-End frame. FIG. 5 illustrates station STA2 transmitting an ACK frame to acknowledge the successful reception of a frame by the recipient.

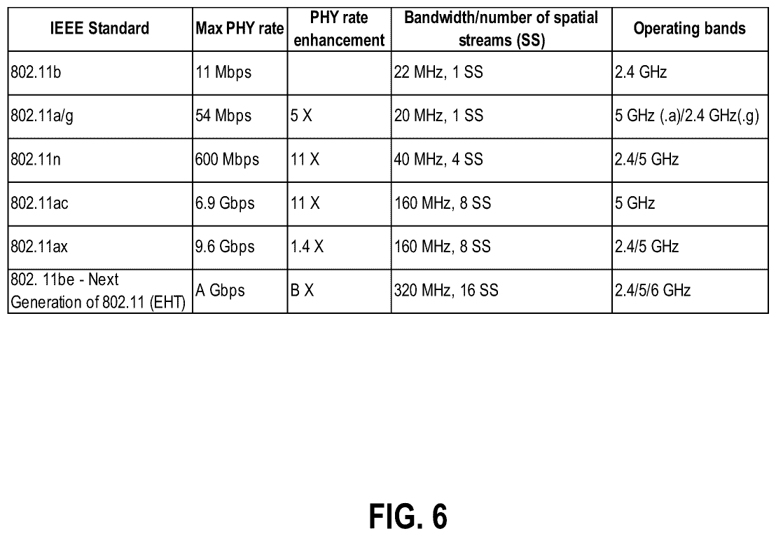

With clear demand for higher peak throughput/capacity in WiFi, a new working group for an amendment called 11be (Extreme High Throughput, EHT) has been created to support an increase in the peak PHY rate. Considering 802.11b to 802.11ac, the peak PHY rate has increased by a factor of 5 or 11, as shown in the table of FIG. 6. In the case of 11ax, known as WiFi 6, the 11ax working group focused on improving efficiency, not peak PHY rate, in dense environments. Note that the Max PHY data rate (in gigabits per second (Gbps)) and PHY rate enhancement (factor) for 11be could rely on the highest MCS (e.g., 4,096 QAM and its code rate) to be determined.

The focus of 11be is on wireless local area network (WLAN) indoor and outdoor operation with stationary and pedestrian speeds in the 2.4, 5, and 6 gigahertz (GHz) frequency bands. In addition to the peak PHY rate, different candidate features are under discussion, include some or all of: 320 MHz bandwidth and more efficient utilization of non-contiguous spectrum; multi-band/multi-channel aggregation and operation; 16 spatial streams and multiple-input, multiple-output (MIMO) protocol enhancements; multi-access point coordination (e.g., coordinated and joint transmission); enhanced link adaptation and retransmission protocol (e.g., Hybrid Automatic Repeat Request (HARQ)); and, if needed, adaptation to regulatory rules specific to the 6 GHz spectrum.

Some features, like increasing the bandwidth and the number of spatial streams, are solutions that have been proven to be effective in previous projects focused on increasing link throughput and for which feasibility demonstration is achievable.

As for operation bands (2.4/5/6 gigahertz (GHz)) for 11be, more than 1 GHz of additional unlicensed spectrum is likely to be available around the year 2020 because the 6 GHZ band (5.925-7.125 GHZ) is being considered for unlicensed use. It would allow access points and stations to become tri-band devices. Larger than 160 MHz data transmission (e.g., 320 MHz) could be considered to increase the max PHY rate. For example, 320 MHz or 160+160 MHz data could be transmitted in the 6 GHz band. Alternatively, 160+160 MHz data could be transmitted across the 5 and 6 GHz bands.

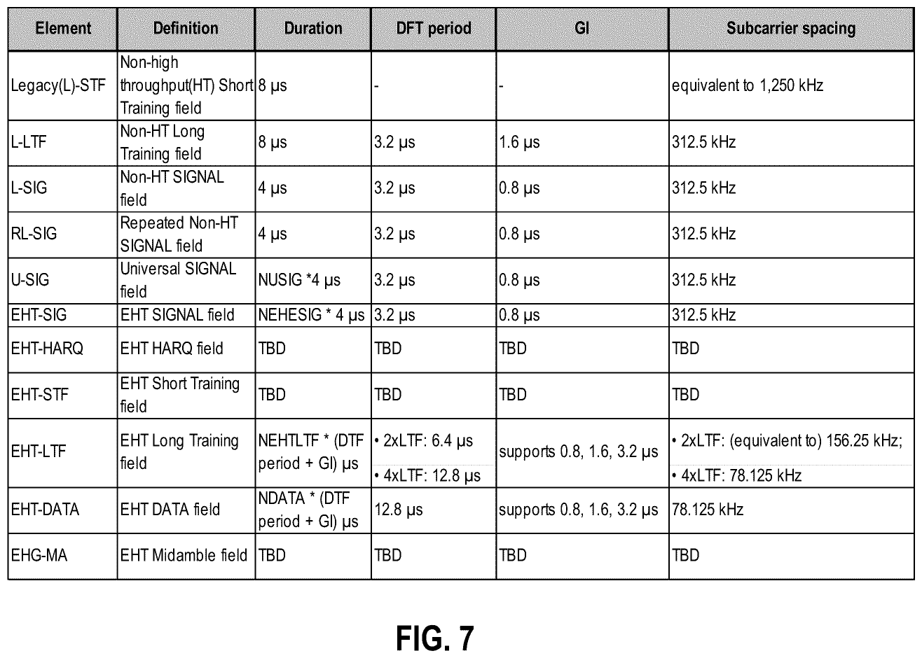

A transmitting station generates a PHY Protocol Data Unit (PPDU) frame and transmits it to a receiving station. The receiving station receives, detects, and processes the PPDU. If an Extremely High Throughput (EHT) PPDU frame comprises a legacy part (e.g., an L-STF field, an L-LTF field, and an L-SIG field), an EHT-SIG-A field, an EHT-SIG-B field, an EHT-HARQ field, an EHT-STF field, an EHT-LTF field, and an EHT-DATA field, then the table of FIG. 7 describes the fields of the EHT PPDU frame in more detail. However, many fields remain empty and are yet to be determined for further discussion.

The distributed nature of channel access networks, such as Institute of Electrical and Electronics Engineers (IEEE) 802.11 wireless local area networks (WLANs), makes the carrier sense mechanism important for collision-free operation. The physical carrier sense of one station is responsible for detecting the transmissions of other stations. However, it may be impossible to detect every single case in some circumstances. For example, one station, which may be a long distance away from another station, may see the medium as idle and begin transmitting frames as well. To overcome this hidden node problem, the network allocation vector (NAV) has been introduced. However, as the IEEE 802.11 standard evolves to include multiple users' simultaneous transmission/reception scheduled within a BSS, such as UL/DL MU transmission in a cascaded manner, modified or newly defined mechanisms may be needed.

In this disclosure, multi-user (MU) transmission refers to cases where multiple frames are transmitted to or from multiple stations simultaneously using different resources, wherein examples of different resources are different frequency resources in OFDMA transmission and different spatial streams in multi-user multiple-input, multiple-output (MU-MIMO) transmission. Therefore, DL-OFDMA, DL-MU-MIMO, UL-OFDMA, and UL-MU-MIMO are examples of MU transmission.

Wireless local area network (WLAN) systems rely on the retransmission of medium access control (MAC) MPDUs when the TX (transmitter) does not receive the acknowledgment from the RX (receiver) OR when MPDUs are not decoded at the RX. In this ARQ (automatic repeat request) approach, the receiver discards the last failed MPDU before receiving the newly retransmitted one. With the requirements for enhanced reliability and reduced latency, the 11be working group decided that it should evolve toward hybrid ARQ (HARQ).

There are two methods of HARQ processing. In the Type 1 HARQ scheme, also referred to as chase combining (CC), the signals to be retransmitted in this part are the same as the signals that failed before because all subpackets to be retransmitted use the same puncturing pattern. Puncturing is needed to remove some of the parity bits after encoding with an error-correction code. The reason for using the same puncturing pattern in CC-HARQ is to generate the coded data sequence with forward error correction (FEC) and make the receiver use maximum-ratio combining (MRC) to combine the received bits with the same bits from previous transmissions. In wireless local area network (WLAN) systems, four subpackets are created from one HARQ packet. For example, the information sequences are usually transmitted in packets with a fixed length. At a receiver, error correction and detection are carried out on the whole packet. If the packet is found to be in error, the conventional ARQ scheme is inefficient in the presence of burst errors. To solve this more efficiently, this situation can be improved if subpackets are applied. In subpacket transmissions, only those subpackets that include errors need to be retransmitted.

With subpackets, since the receiver uses both the current and the previously received subpackets to decode, the error probability in decoding decreases as the number of used subpackets increases. The decoding process passes the CRC check and ends when the packet is decoded without errors or the maximum number of subpackets is reached. Basically, because it operates in the stop-and-wait protocol, if the terminal can decode the packet, it sends an ACK to the transmitter. When the transmitter receives the ACK correctly, it terminates the HARQ transmission of the packet. If the terminal cannot decode the packet, it sends a NAK to the transmitter, and the transmitter performs the retransmission process.

In the Type 2 HARQ scheme, also referred to as Incremental Redundancy (IR), different puncturing patterns are used for each subpacket, so the signal of this portion changes for each subpacket. IR uses two puncturing patterns, alternating for odd-numbered and even-numbered transmissions, respectively, resulting in the coded data sequence with the coding rate which is used in IR HARQ. The redundancy scheme of IR improves the LLR (Log Likelihood Ratio) of the parity bits in order to combine information sent across different transmissions due to requests and lowers the code rate as additional subpackets are used, resulting in a lower error rate of the subpackets than CC. The puncturing pattern used in HARQ is indicated by the Subpacket Identity (SPID). The SPID of the first subpacket is always set to 0, and all the systematic bits and the punctured parity bits are transmitted in the first subpacket, and self-decoding is possible when the receiving SNR environment is good. Generally, subpacket SPIDs to be transmitted are in increasing order but can be exchanged except for the first SPID.

As wireless local area network (WLAN) systems have improved, access point coordination has been discussed as a possible technology to be adopted in 11be, where there is a high-level classification depending on various access point coordination schemes. For example, there are two main types of techniques: the first type, called “coordinated,” where data for a user is sent from a single access point, and the second type, called “joint,” where data for a user is sent from multiple access points.

As for coordinated access point tech, multiple access points are either 1) transmitting on the same frequency resource based on coordination and forming spatial nulls to allow for simultaneous transmission from multiple access points, or 2) transmitting on orthogonal frequency resources by coordinating and splitting the spectrum to use it more efficiently. As for joint access point tech, multiple access points are transmitting jointly to a given user.

The solutions provided herein have been described with reference to a wireless LAN system; however, it should be understood that these solutions are also applicable to other network environments, such as cellular telecommunication networks, wired networks, etc.

An embodiment of the invention may be an article of manufacture in which a non-transitory machine-readable medium (such as microelectronic memory) has stored thereon instructions which program one or more data processing components (generically referred to here as a “processor” or “processing unit”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment of the invention may be an apparatus (e.g., an access point station, a non-access point station, or another network or computing device) that includes one or more hardware and software logic structures for performing one or more of the operations described herein. For example, as described above, the apparatus may include a memory unit, which stores instructions that may be executed by a hardware processor installed in the apparatus. The apparatus may also include one or more other hardware or software elements, including a network interface, a display device, etc.

In the conventional Institute of Electrical and Electronics Engineers (IEEE) 802.11 standards, including IEEE 802.11be, stations can transmit their own packets after sensing the channel according to the distributed coordination function (DCF) rule. In a dense network where multiple basic service sets (BSSs) are overlapped, therefore, there exist collision and spectrum under-utilization problems. To avoid such problems, a spatial reuse scheme was proposed in IEEE 802.11. However, the current spatial reuse scheme still has limitations to increase the efficiency in spectral utilization.

In the current spatial reuse transmissions, both modes (e.g., overlapping basic service set packet detection and parameterized spatial reuse) are passive. This means that stations in different BSSs have no knowledge about their frequency resources being used. In overlapping basic service set packet detection, the clear channel assessment (CCA) threshold is dynamically adjusted to allow stations in one BSS to ignore frames from other BSSs, which are typically some distance away. In parameterized spatial reuse (PSR), an access point controls the transmit power of stations to minimize the interference effects on the transmission of other BSSs. Therefore, the existing spatial reuse modes do not concern how the signals in different BSSs are constructed and transmitted.

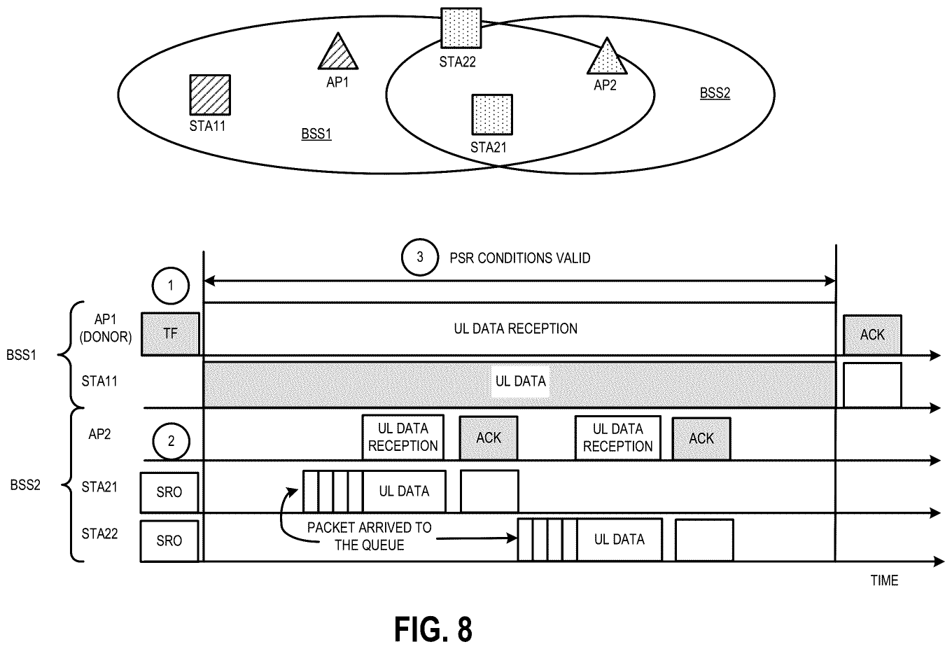

In FIG. 8, an example of parameterized spatial reuse (PSR) operation in an overlapping basic service set (OBSS) is shown. Two basic service sets (BSSs), e.g., BSS1 (AP1, STA11) and BSS2 (AP2, STA21, STA22), are overlapping. STA11 transmits its uplink packet after receiving the trigger frame (TF) from AP1, and AP1 sends back the ACK frame. In the conventional operation without spatial reuse, STA21 and STA22 cannot start their transmission because the TF sets an NAV to protect the uplink (UL) data frame from the triggered station, i.e., STA11. However, BSS2 can make links by using the PSR mechanism as follows:

(1) the donor AP1 can trigger STA11 for uplink transmission and set the TF field that allows PSR operation. In the TF, PSR_INPUT parameter is included, which is given by:

$$PSR\_INPUT = {TX\_PWR}_{A P} + {I}_{A P}$$

Here, TX_PWR_{AP} is the power used by the AP1 to transmit the trigger frame (TF) in decibel-milliwatts (dBm). Additionally, AP1 defines an acceptable interference level, I_{AP}, as the maximum interference that can be perceived by the transmission opportunity (TXOP) holder, e.g., AP1, without compromising its transmission as follows:

$${I}_{A P} = UL\_Target \_RSSI - Min\_SNR \_MCS - Safety\_Margin$$

Here, UL_Target_RSSI denotes the upload (UL) target received signal strength indicator (RSSI) in dBm indicated in the trigger frame (TF). Min SNR MCS is the minimum signal-to-noise ratio (SNR) value that yields the acceptable packet error rate (PER) performance, e.g., 10%, for the highest modulation and coding scheme (MCS) of the following uplink data transmission. Safety Margin is a margin for implementation that should not exceed 5 decibels (dB).

Min SNR MCS is the minimum signal-to-noise ratio (SNR) value that yields the acceptable packet error rate (PER) performance, e.g., 10%, for the highest modulation and coding scheme (MCS) of the following uplink data transmission, and Safety Margin is a margin for implementation that should not exceed 5 dB.

(2) STA21 and STA22 receive an inter-BSS trigger frame (TF) from AP1 allowing PSR with a parameter PSR_INPUT. Both stations can grab spatial reuse opportunities.

(3) If the duration of transmission triggered by AP1 is very long, both STA21 and STA22 can transmit their short packets within the currently set spatial reuse opportunity as soon as the packets arrive in the queue.

These above steps (1), (2), and (3) are depicted in FIG. 8 with circle numbers.

If the transmit powers of STA21 and STA22, e.g., TX_PWR_{STA}, are determined by the following equation, then the interference from STA21 and STA22 do not interrupt the uplink (UL) data packet from STA11 to AP1.

$${TX\_PWR}_{STA} - 10 * {log}_{10} ( {TX\_BW}_{STA} / 20 MHz ) \leq PSR\_INPUT - RPL$$

Here, TX_BW_{STA} is the intended transmission bandwidth in megahertz (MHZ) and RPL is the received power level that indicates the receiving power of the trigger frame (TF).

By applying the upper limit of transmit power of overlapping basic service set stations, the coexisting overlapping basic service set transmissions do not cause harmful effects on the BSS owned by the donor AP1.

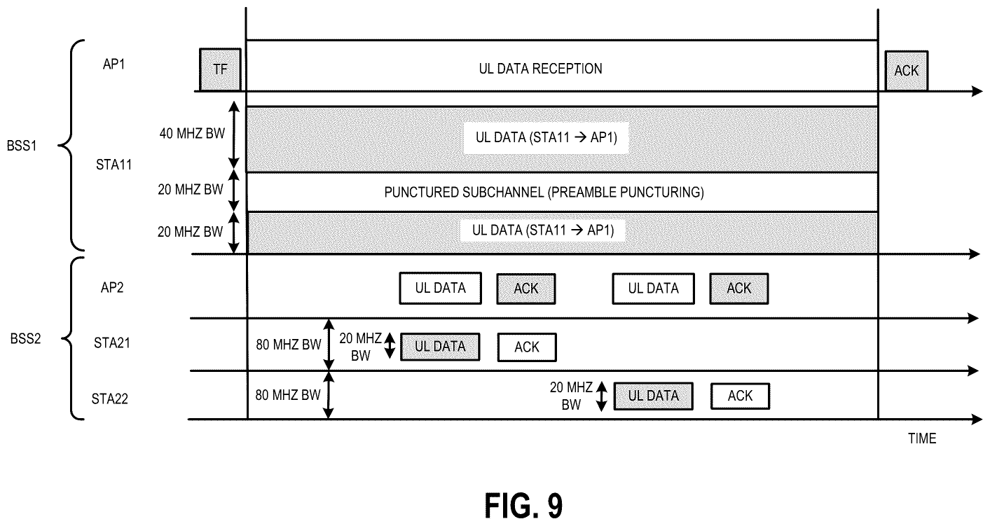

In Institute of Electrical and Electronics Engineers (IEEE) 802.11ax, the projection of the uplink (UL) data packet is based on the transmitted packets from an access point in an overlapping basic service set, e.g., AP2 in FIG. 9. By extending the parameterized spatial reuse (PSR) mentioned previously, an upper limit on the transmit power of packets from overlapping basic service set access points can be set as follows:

$${TX\_PWR}_{A P 2} - 10 * {log}_{10} ( {TX\_BW}_{A P 2} / 20 MHz ) \leq PSR\_INPUT - RPL$$

To this end, AP2 should receive the trigger frame (TF) from AP1 in the overlapping basic service set. Therefore, it can be regarded as one of multi-access point coordination.

In the above parameterized spatial reuse (PSR) schemes, the frequency or resource unit allocation of the uplink (UL) data frame is not considered. It means that the uplink (UL) data packet in the basic service set (BSS) of the donor access point occupies a consecutive frequency band without any puncturing.

Turning now to FIG. 9, it illustrates an example of spatial reuse with preamble-punctured transmissions. In particular, the example of FIG. 9 illustrates a case where a preamble-punctured uplink (UL) packet, e.g., puncturing in the unit of a 20 MHz subchannel, is used. In FIG. 9, the same network topology and frame exchange sequence as in FIG. 8 is assumed. However, in the example of FIG. 9, the uplink (UL) data packet includes a punctured 20 MHz subchannel. Because this punctured bandwidth information is included in the trigger frame (TF), as well as an indication to allow spatial reuse of the punctured bandwidth, the overlapping basic service set stations which receive the trigger frame (TF) from AP1, e.g., STA21 and STA22, can use the punctured 20 MHz subchannel. Here, overlapping basic service set packets from STA21 and STA22 can be transmitted with their maximum power. If the out-of-band emission of overlapping basic service set packets can cause interference with the uplink (UL) data packets, the information needed for the calculation of the maximum allowed transmit power, which is much higher than the transmit power limit in the conventional parameterized spatial reuse (PSR) scheme, can be included in the trigger frame (TF), according to the requirements of the particular implementation at hand.

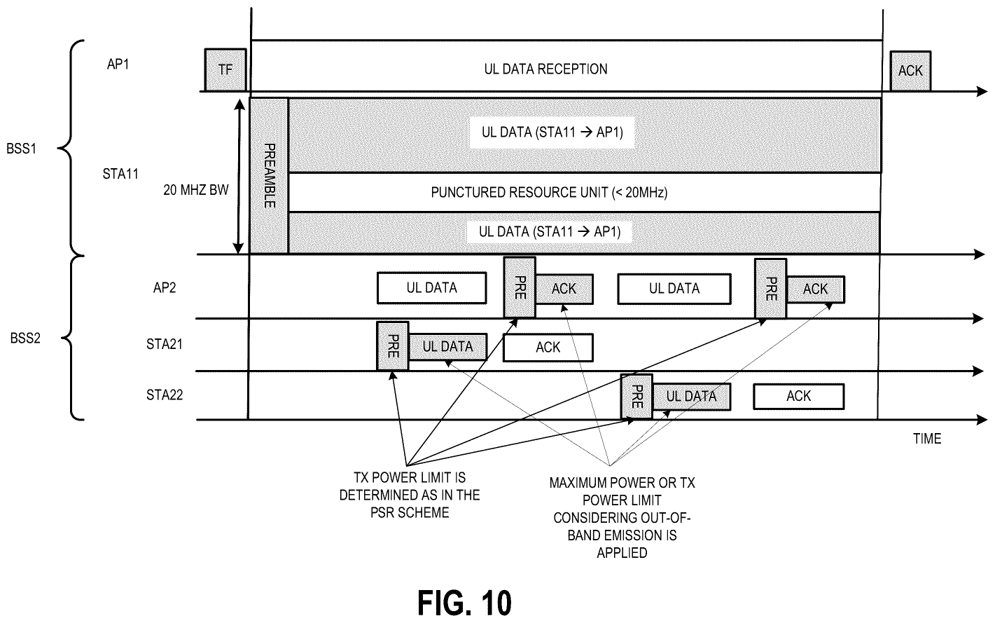

Turning to FIG. 10, it illustrates an example of spatial reuse with punctured resource unit transmissions. In FIG. 10, an uplink (UL) packet occupies a punctured resource unit which is less than 20 MHz. In punctured resource unit packets, the preamble part occupies a 20 MHz channel without puncturing, and the following data part occupies the used resource units with puncturing. In FIG. 10, the same network topology and frame exchange sequence as in FIG. 8 is assumed. However, the uplink (UL) data packet includes a punctured resource unit (which is less than 20 MHz). Because this punctured resource unit information is included in the trigger frame (TF), as well as an indication to allow spatial reuse of the punctured resource unit, the overlapping basic service set stations, which receive the trigger frame (TF) from AP1, e.g., STA21 and STA22, can use the punctured resource unit. Even in the overlapping basic service set packets, the preamble part occupies the whole 20 MHz bandwidth. Therefore, such a wideband preamble can interfere with the uplink (UL) data packet. On the other hand, the data part of the overlapping basic service set packet may not cause interference with the uplink (UL) packet. Hence, the preamble of overlapping basic service set packets from STA21 and STA22 can be transmitted with limited power as defined in the conventional parameterized spatial reuse (PSR) scheme. The data part of overlapping basic service set packets can use the maximum transmit power if out-of-band emission is sufficiently low to be ignored. If the out-of-band emission of the data part of overlapping basic service set packets is not sufficiently low, the information needed for the calculation of the maximum allowed transmit power for the data part, which is higher than the transmit power limit in the preamble part, can be included in the trigger frame (TF), according to the requirements of the particular implementation at hand.

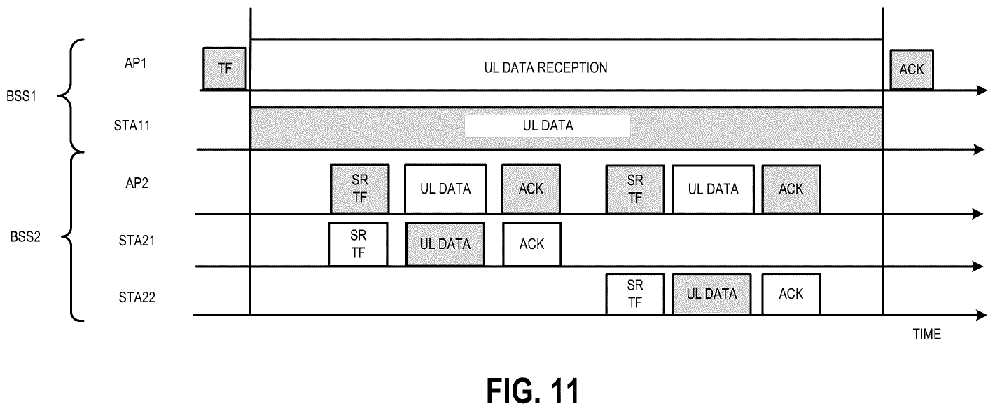

Turning now to FIG. 11, it illustrates an example of spatial reuse-trigger frame (SR-TF)-based spatial reuse transmissions. In particular, FIG. 11 illustrates a coordinated spatial reuse scheme considering the channel quality indicator of the uplink (UL) packet. To this end, a spatial reuse-trigger frame (SR-TF) is defined for triggering the overlapping basic service set uplink (UL) transmission as in FIG. 11. In the SR-TF-based spatial reuse transmission, the transmit power of the SR-TF and (acknowledgement) ACK transmission is determined by the conventional parameterized spatial reuse scheme. And it is assumed that AP2 knows the channel quality index between AP1 and STA11, e.g., the link in BSS1. In a coordinated access point mechanism, AP1 and AP2 may exchange channel information, including channel quality index information, for cooperation.

If spatial reuse transmissions in BSS2 are conducted in a good channel (in terms of the AP1-STA11 channel), the transmit power of spatial reuse packets can increase, e.g., the data rate of SR can increase.

In the disclosed SR-TF-based spatial reuse transmission mechanism, the good subchannel information (e.g., the spatial reuse subchannel where spatial reuse transmissions in the overlapping basic service set are conducted) can be included in the trigger frame (TF) (e.g., of AP1). The spatial reuse transmissions in the overlapping basic service set are conducted in this subchannel. The subchannel that will be used for spatial reuse transmissions can be informed in the SR-TF (e.g., of AP2).

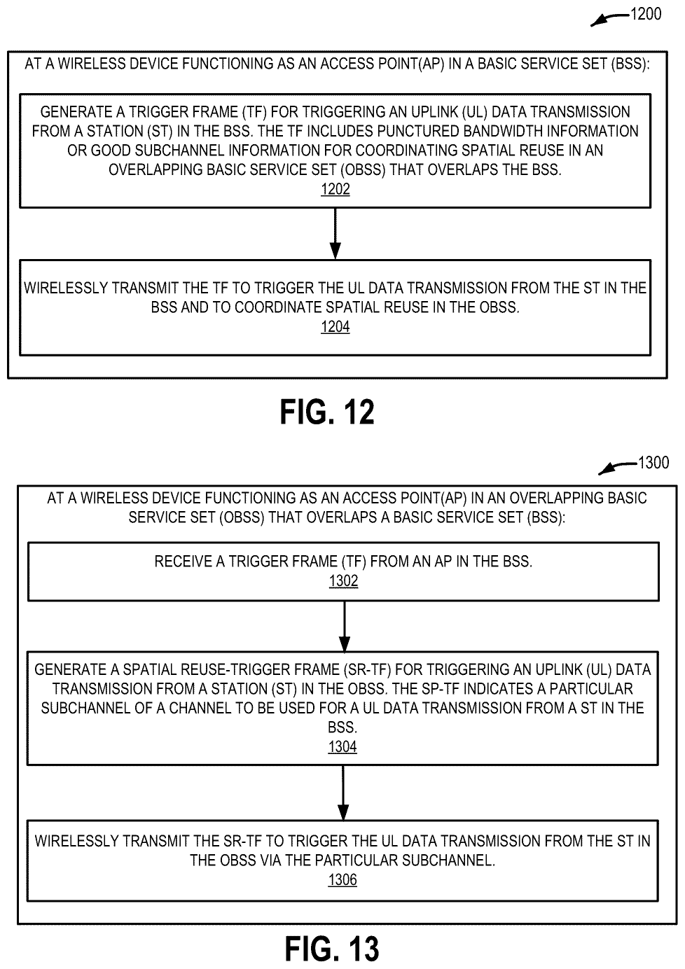

FIG. 12 is a flowchart of a method 1200 for coordinated spatial reuse and frequency utilization in an overlapping basic service set environment at a wireless device functioning as an access point in a basic service set.

The method (1200) depicted in FIG. 12 is performed by a wireless device functioning as an access point (AP) in a basic service set (BSS). The method involves generating (1202) a trigger frame to initiate an uplink data transmission from a station within the same BSS. The trigger frame includes specific information to coordinate spatial reuse in an overlapping basic service set (OBSS) that overlaps with the current BSS. This information can be either punctured bandwidth information, indicating which portions of the bandwidth are unavailable due to interference, or good subchannel information, specifying the subchannels that are suitable for transmission. By including this information in the trigger frame, the AP effectively communicates to the station which resources are available for spatial reuse in the OBSS. After generating (1202) the trigger frame, the AP wirelessly transmits (1204) it to the station, triggering the uplink data transmission and simultaneously coordinating spatial reuse in the OBSS. This method (1200) allows for more efficient utilization of the available spectrum by enabling the station to transmit on resources that are not being used by the OBSS, thus reducing interference and increasing overall network throughput.

In the method (1200), the wireless device functioning as an access point is a device that operates as a central hub or coordinator within a basic service set (BSS) in a wireless network. The access point (AP) is responsible for managing and controlling the wireless communication within its BSS. It acts as a bridge between the wireless stations (STAs) in the BSS and the wired network infrastructure, enabling the STAs to connect to the network and communicate with each other through the AP. The AP broadcasts beacon frames to announce its presence, maintains a list of associated STAs, and coordinates the transmission and reception of data frames within the BSS. In the method (1200), the wireless device functioning as an AP performs specific tasks, such as generating and transmitting a trigger frame, to facilitate efficient spatial reuse and coordinate the uplink data transmissions from the STAs in its BSS, while considering the presence of an overlapping basic service set (OBSS) in the vicinity.

In the context of the method (1200), a “trigger frame” is a special type of frame generated by the wireless device functioning as an access point (AP) in a basic service set (BSS). The primary purpose of the trigger frame is to initiate or trigger an uplink data transmission from a station (STA) within the BSS. The trigger frame contains essential information and instructions that the STA needs to follow for the uplink data transmission.

In the method (1200), the trigger frame serves an additional purpose of coordinating spatial reuse in an overlapping basic service set (OBSS) that coexists with the BSS. To facilitate this coordination, the trigger frame includes specific information, such as punctured bandwidth information or good subchannel information.

The punctured bandwidth information indicates a specific portion of the bandwidth that should be left unused by the STA during its uplink data transmission, allowing the OBSS to utilize that portion for its own transmissions. Additionally, or alternatively, the good subchannel information identifies a particular subchannel that the STA should use for its uplink data transmission, ensuring minimal interference with the OBSS.

In the context of method (1200), the station in the basic service set is a wireless device that is associated with and communicates through the access point (AP) within the basic service set (BSS). A station (STA) is typically a client device, such as a laptop, smartphone, tablet, or IoT device, that connects to the wireless network to send and receive data.

When a STA joins a BSS, it goes through an association process with the AP to establish a logical connection. Once associated, the STA becomes a member of the BSS and can actively participate in the wireless communication within that BSS. The AP manages and coordinates the communication activities of all the associated STAs within its BSS.

In method (1200), the trigger frame generated by the AP is specifically intended for a STA within its BSS. The trigger frame contains information and instructions that the targeted STA must follow to initiate its uplink data transmission. The STA, upon receiving the trigger frame, adheres to the specified guidelines, such as using the indicated punctured bandwidth or good subchannel, to send its data to the AP.

In the context of method (1200), the overlapping basic service set (OBSS) refers to a separate basic service set (BSS) that partially or fully overlaps with the coverage area of the primary BSS of the method (1200). In other words, an OBSS is another wireless network, managed by a different access point (AP), that operates on the same or adjacent channels and has a coverage area that intersects with the primary BSS.

When multiple BSSs operate in close proximity and have overlapping coverage areas, they can interfere with each other, leading to reduced network performance and efficiency. In such scenarios, the APs and stations (STAs) in the overlapping BSSs compete for the same wireless resources, such as channels and airtime, which can result in collisions, increased latency, and decreased throughput.

To mitigate the negative impact of OBSSs and promote efficient spatial reuse, the AP in the primary BSS generates (1202) a trigger frame that includes specific information for coordinating spatial reuse. This information, in the form of punctured bandwidth information or good subchannel information, helps the STAs in the primary BSS to transmit their uplink data in a manner that minimizes interference with the OBSSs.

By considering the presence of OBSSs and including spatial reuse coordination information in the trigger frame, the AP in the primary BSS actively manages the coexistence of multiple wireless networks in the same vicinity. This approach allows the primary BSS and the OBSSs to operate simultaneously and efficiently, improving overall network performance and spectrum utilization in dense wireless environments.

In an embodiment of the method (1200), the trigger frame generated (1202) by the wireless device functioning as an access point (AP) in a basic service set (BSS) specifically includes punctured bandwidth information for coordinating spatial reuse in the overlapping basic service set (OBSS). The punctured bandwidth information indicates a particular subchannel, referred to as the puncture subchannel, that should remain unused by the station in the BSS during its uplink data transmission. By specifying the puncture subchannel, the AP effectively instructs the station to avoid transmitting on that particular subchannel, leaving it available for use by devices in the OBSS.

In an embodiment of the method (1200), the trigger frame generated (1202) by the wireless device functioning as an access point (AP) in a basic service set (BSS) not only includes punctured bandwidth information indicating a puncture subchannel but also specifies the width of this puncture subchannel as 20 MHz. By explicitly stating the width of the puncture subchannel in the trigger frame, the AP provides clear instructions to the station in the BSS regarding the specific portion of the bandwidth that should remain unused during its uplink data transmission. This 20 MHz-wide puncture subchannel can then be utilized by devices in the overlapping basic service set (OBSS) for their own transmissions, thereby promoting efficient spatial reuse. The specific width of 20 MHz for the puncture subchannel provides a balance between allowing sufficient bandwidth for the BSS's uplink data transmission and reserving enough bandwidth for spatial reuse in the OBSS. However, other puncture subchannel widths that strike such a balance can be used according to the requirements of the particular implementation at hand.

In an embodiment of the method (1200), the trigger frame generated (1202) by the wireless device functioning as an access point (AP) in a basic service set (BSS) includes not only punctured bandwidth information indicating a puncture subchannel but also an explicit indication to allow spatial reuse of this puncture subchannel in the overlapping basic service set (OBSS). By incorporating this indication in the trigger frame, the AP actively encourages devices in the OBSS to utilize the puncture subchannel for their own transmissions, thereby promoting efficient spatial reuse. This indication serves as a clear signal to devices in the OBSS that they are permitted to transmit on the puncture subchannel, which is being purposely left unused by the station in the BSS during its uplink data transmission. By explicitly allowing spatial reuse of the puncture subchannel, the AP facilitates more efficient utilization of the available spectrum and reduces the chances of the puncture subchannel remaining idle.

In an embodiment of the method (1200), the punctured bandwidth information included in the trigger frame generated (1202) by the wireless device functioning as an access point (AP) in a basic service set (BSS) not only indicates a puncture subchannel but also includes spatial reuse power control information. This power control information is used to calculate the maximum allowed transmit power for transmissions in the overlapping basic service set (OBSS) that utilize the puncture subchannel. By providing this information in the trigger frame, the AP enables devices in the OBSS to determine the appropriate transmit power level when using the puncture subchannel, ensuring that their transmissions do not cause excessive interference to the uplink data transmission from the station in the BSS. The spatial reuse power control information may include parameters such as the maximum allowable transmit power, path loss estimates, or other relevant factors that can be used to calculate the optimal transmit power for OBSS devices. By dynamically adjusting the transmit power of OBSS devices based on the provided information, the AP promotes more efficient spatial reuse while minimizing the impact of OBSS transmissions on the BSS's uplink data transmission.

In an embodiment of the method (1200), subsequent actions are taken by the wireless device functioning as an access point (AP) in a basic service set (BSS) after transmitting (1204) the trigger frame. In this case, after sending (1204) the trigger frame that includes punctured bandwidth information indicating a puncture subchannel, the AP receives the uplink data transmission from the station in the BSS. However, this uplink data transmission occurs via a specific portion of the punctured bandwidth channel, which excludes the puncture subchannel. In other words, the station in the BSS transmits its uplink data using the available bandwidth within the punctured channel, while intentionally avoiding the puncture subchannel that was indicated in the trigger frame. By transmitting the uplink data in this manner, the station adheres to the instructions provided by the AP and ensures that the puncture subchannel remains unused, allowing devices in the overlapping basic service set (OBSS) to utilize it for their own transmissions.

In an embodiment if the method (1200), the trigger frame generated (1202) by the wireless device functioning as an access point (AP) in a basic service set (BSS) includes punctured bandwidth information for coordinating spatial reuse in the overlapping basic service set (OBSS). However, instead of indicating a puncture subchannel described above, the punctured bandwidth information specifically indicates a puncture resource unit (RU) that should remain unused by the payload portion of the uplink data transmission from the station in the BSS. A resource unit is a specific allocation of time and frequency resources within the overall bandwidth, and by designating a particular RU as the puncture RU, the AP effectively instructs the station to avoid using that RU for the payload portion of its uplink data transmission. This means that while the station may still use the puncture RU for other purposes, such as transmitting control information or pilot signals, it will not transmit the actual data payload in that RU. By leaving the puncture RU unused for the payload, the station creates an opportunity for devices in the OBSS to utilize that RU for their own transmissions, thereby enabling spatial reuse. This approach offers a more granular control over the resources used for spatial reuse compared to the puncture subchannel method above, as it allows the AP to specify a specific RU rather than an entire subchannel. By indicating the puncture RU in the trigger frame, the AP promotes efficient spatial reuse and reduces interference between the BSS and OBSS, ultimately improving overall network performance.

An embodiment of the method (1200) further refines the characteristics of the puncture resource unit (RU) mentioned above. In this case, the size of the puncture RU indicated in the trigger frame generated by the wireless device functioning as an access point (AP) in a basic service set (BSS) is specified to be less than 20 MHz. This means that the portion of the bandwidth that the station in the BSS is instructed to leave unused for the payload of its uplink data transmission is smaller than the 20 MHz puncture subchannel described above. By indicating a puncture RU with a size less than 20 MHz, the AP enables more precise control over the resources allocated for spatial reuse in the overlapping basic service set (OBSS). This approach allows for a more granular division of the available bandwidth, where smaller portions can be reserved for spatial reuse while still allowing the station in the BSS to utilize the remaining resources for its uplink data transmission. The smaller size of the puncture RU offers increased flexibility in resource allocation and can be particularly beneficial in scenarios where the overall bandwidth is limited, or when multiple devices in the OBSS require access to the shared spectrum. By specifying the size of the puncture RU as less than 20 MHz in the trigger frame, the AP optimizes the balance between enabling spatial reuse and maximizing the resources available for the BSS's uplink data transmission, ultimately leading to improved network efficiency and performance.

In an embodiment of the method (1200), the trigger frame generated (1202) by the wireless device functioning as an access point (AP) in a basic service set (BSS) includes not only punctured bandwidth information indicating a puncture resource unit (RU) but also an explicit indication to allow spatial reuse of this puncture RU in the overlapping basic service set (OBSS). By incorporating this indication in the trigger frame, the AP actively encourages devices in the OBSS to utilize the puncture RU for their own transmissions, thereby promoting efficient spatial reuse. This indication serves as a clear signal to devices in the OBSS that they are permitted to transmit on the puncture RU, which is being intentionally left unused by the station in the BSS for the payload portion of its uplink data transmission. By explicitly allowing spatial reuse of the puncture RU, the AP facilitates more efficient utilization of the available spectrum and reduces the chances of the puncture RU remaining idle.

In an embodiment of the method (1200), the punctured bandwidth information included in the trigger frame generated (1202) by the wireless device functioning as an access point (AP) in a basic service set (BSS) not only indicates a puncture resource unit (RU) but also includes spatial reuse power control information. This power control information is used to calculate the maximum allowed transmit power for data transmissions in the overlapping basic service set (OBSS) that utilize the puncture RU. By providing this information in the trigger frame, the AP enables devices in the OBSS to determine the appropriate transmit power level when using the puncture RU for their data transmissions, ensuring that their transmissions do not cause excessive interference to the uplink data transmission from the station in the BSS. The spatial reuse power control information may include parameters such as the maximum allowable transmit power, path loss estimates, or other relevant factors that can be used to calculate the optimal transmit power for OBSS devices. By dynamically adjusting the transmit power of OBSS devices based on the provided information, the AP promotes more efficient spatial reuse while minimizing the impact of OBSS transmissions on the BSS's uplink data transmission.

In an embodiment of the method (1200), the AP receives the uplink data transmission from the station in the BSS in two distinct parts: the preamble portion and the payload portion. The preamble portion of the uplink data transmission is received via a punctured bandwidth channel that includes the puncture resource unit (RU) mentioned in the trigger frame. This means that the station in the BSS transmits the preamble using the entire available bandwidth, including the puncture RU. The preamble typically contains important control information and helps the AP to synchronize and prepare for the upcoming payload portion of the transmission. On the other hand, the payload portion of the uplink data transmission, which carries the actual data being sent by the station, is received by the AP via a portion of the punctured bandwidth channel that excludes the puncture RU. This means that the station in the BSS transmits the payload using the available bandwidth within the punctured channel, while intentionally avoiding the puncture RU that was indicated in the trigger frame. By transmitting the preamble and payload portions of the uplink data transmission in this manner, the station adheres to the instructions provided by the AP and ensures that the puncture RU remains unused for the payload, allowing devices in the overlapping basic service set (OBSS) to utilize it for their own transmissions.

In an embodiment of the method (1200), the trigger frame generated (1202) by the wireless device functioning as an access point (AP) in a basic service set (BSS) includes good subchannel information for coordinating spatial reuse in the overlapping basic service set (OBSS), in addition to or instead of the punctured bandwidth information mentioned above. The good subchannel information identifies a specific subchannel within the overall channel that should be used by the station in the BSS for its uplink data transmission. By indicating a particular subchannel as a “good” subchannel, the AP effectively instructs the station to use that subchannel for transmitting its uplink data. This good subchannel is selected based on various factors, such as the interference levels, channel quality, and spatial reuse opportunities in the OBSS. The AP may have knowledge of the channel conditions and the spatial reuse requirements of the OBSS through coordination with other APs or by analyzing the wireless environment. By designating a specific subchannel as a good subchannel in the trigger frame, the AP guides the station in the BSS to transmit its uplink data on a portion of the channel that is less likely to cause interference to the OBSS and more likely to facilitate effective spatial reuse.

In an embodiment of the method (1200), the functionality of the spatial reuse trigger frame mentioned above is extended. In this case, the spatial reuse trigger frame includes not only the good subchannel information for coordinating spatial reuse in the overlapping basic service set (OBSS) but also spatial reuse power control information. This power control information is used to calculate the maximum allowed transmit power for the uplink data transmission from the station in the BSS via the particular subchannel identified as the good subchannel. By providing this information in the spatial reuse trigger frame, the AP enables the station in the BSS to determine the appropriate transmit power level when using the good subchannel for its uplink data transmission. This ensures that the station's transmission does not cause excessive interference to other devices in the OBSS that may be using adjacent subchannels or the same subchannel for their own communications. The spatial reuse power control information may include parameters such as the maximum allowable transmit power, path loss estimates, or other relevant factors that can be used to calculate the optimal transmit power for the station in the BSS. By dynamically adjusting the transmit power based on the provided information, the AP promotes efficient spatial reuse while minimizing the impact of the BSS's uplink data transmission on the OBSS.

FIG. 13 is a flowchart of a method (1300) for coordinated spatial reuse and frequency utilization in an overlapping basic service set environment at a wireless device functioning as an access point in the overlapping basic service set that overlaps the basic service set of the method 1200 of FIG. 12.

The method (1300) is an extension of the method (1200) of FIG. 12 and introduces the actions taken by a wireless device functioning as an access point (AP) in the overlapping basic service set (OBSS) in response to the trigger frame transmitted (1204) by the AP in the basic service set (BSS). In this case, the AP in the OBSS receives (1302) the trigger frame that includes the good subchannel information for coordinating spatial reuse. Upon receiving this trigger frame, the AP in the OBSS generates (1304) its own spatial reuse trigger frame to trigger an uplink data transmission from a station within the OBSS. The spatial reuse trigger frame generated by the AP in the OBSS specifically indicates the particular subchannel that was identified as the good subchannel in the original trigger frame received from the AP in the BSS. By including this information in the spatial reuse trigger frame, the AP in the OBSS instructs the station in the OBSS to use the same good subchannel for its uplink data transmission. This ensures that the uplink data transmissions from both the BSS and OBSS occur on the same subchannel, thereby maximizing the spatial reuse opportunities and minimizing interference between the overlapping networks. After generating the spatial reuse trigger frame, the AP in the OBSS wirelessly transmits (1306) it to the station in the OBSS, triggering the uplink data transmission from that station via the particular subchannel. By sharing the good subchannel information and aligning the uplink data transmissions from their respective stations, the APs optimize the use of the available spectrum and improve overall network performance in the presence of overlapping wireless networks.

As used herein, a “channel” refers to a specific portion of the wireless spectrum that is used for communication between devices in a wireless network. A channel is typically defined by its center frequency and bandwidth, which determine the range of frequencies that the channel occupies.

In wireless networks, such as those based on the IEEE 802.11 (Wi-Fi) standards, multiple channels are available for use. These channels are designated by their channel numbers and are spaced apart in frequency to minimize interference between adjacent channels. For example, in the 2.4 GHz band, there are typically 14 channels available, with each channel having a bandwidth of 20 MHZ.

In method (1300), the trigger frame generated by the access point (AP) in the basic service set (BSS) includes good subchannel information that identifies a particular subchannel of a channel to be used for the uplink data transmission from the station (STA) in the BSS. A subchannel is a smaller portion of the overall channel bandwidth, which can be used for more granular resource allocation and spatial reuse coordination.

The AP in the overlapping basic service set (OBSS) receives this trigger frame and generates its own spatial reuse trigger frame, specifying the same particular subchannel for the uplink data transmission from the STA in the OBSS. By aligning the uplink transmissions from STAs in both the BSS and OBSS to the same subchannel, the APs ensure efficient spatial reuse and minimize interference between the overlapping wireless networks.

A channel and its division into subchannels enables more precise control over spectrum utilization and allows for better coordination of wireless resources in dense and overlapping network environments.

In the context of method (1300), the uplink data transmission sends data from a station (STA) to its associated access point (AP) within a wireless network. Uplink transmissions are initiated by the STAs and are directed towards the AP, which serves as a central hub for managing and forwarding the data to its intended destination.

In method (1300), the uplink data transmission is triggered by a spatial reuse trigger frame generated by the AP in the overlapping basic service set (OBSS). This spatial reuse trigger frame is created in response to the original trigger frame sent by the AP in the basic service set (BSS), which includes good subchannel information for coordinating spatial reuse.

The spatial reuse trigger frame instructs the STA in the OBSS to perform an uplink data transmission using the particular subchannel specified in the frame. This subchannel is the same as the one indicated in the original trigger frame, ensuring that the uplink transmissions from STAs in both the BSS and OBSS occur on the same specific portion of the channel.

By coordinating the uplink data transmissions from STAs in overlapping wireless networks to use the same subchannel, the APs effectively manage spatial reuse and minimize interference. This allows multiple STAs in different BSSs to transmit their data simultaneously, improving overall network efficiency and capacity.

The uplink data transmission typically includes the actual data payload that the STA wants to send to the AP, along with any necessary control information and headers. The AP, upon receiving the uplink data transmission, processes the data and forwards it to the appropriate destination, either within the same wireless network or to an external network via a wired connection.

In the context of method (1300), the spatial reuse trigger frame is a special type of frame generated by the access point (AP) in the overlapping basic service set (OBSS) to facilitate spatial reuse and coordinate uplink data transmissions from stations (STAs) within its own network.

The spatial reuse trigger frame is created in response to the original trigger frame sent by the AP in the basic service set (BSS). The original trigger frame includes good subchannel information, which identifies a particular subchannel of the channel to be used for uplink data transmissions in the BSS.

Upon receiving the original trigger frame, the AP in the OBSS generates its own spatial reuse trigger frame. This frame serves two main purposes: (1) It triggers an uplink data transmission from a STA within the OBSS, instructing the STA to initiate the transmission of its data to the AP. (2) It indicates the particular subchannel that the STA in the OBSS should use for its uplink data transmission. This subchannel is the same as the one specified in the original trigger frame received from the AP in the BSS.

By including the specific subchannel information in the spatial reuse trigger frame, the AP in the OBSS ensures that the uplink data transmissions from STAs in both the BSS and OBSS occur on the same portion of the channel. This coordination helps to minimize interference between the overlapping wireless networks and promotes efficient spatial reuse.

The spatial reuse trigger frame acts as a control mechanism for the AP in the OBSS to manage the uplink data transmissions within its own network while collaborating with the AP in the BSS to optimize the use of the available wireless resources. By aligning the uplink transmissions to the same subchannel, the APs facilitate simultaneous communications in overlapping networks, improving overall network performance and capacity.

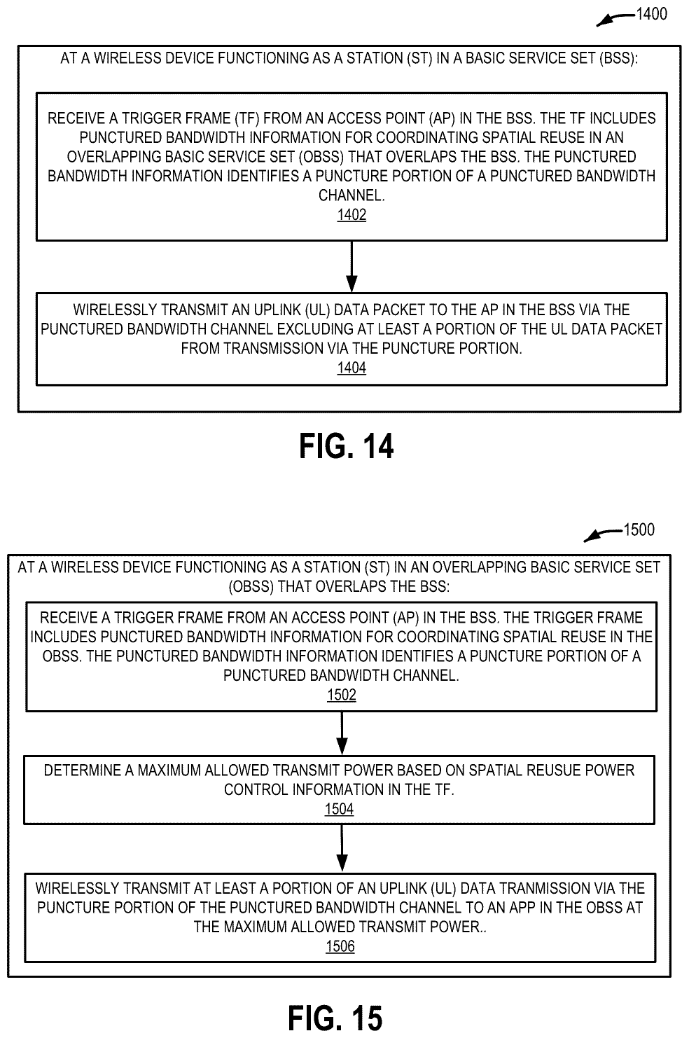

FIG. 14 is a flowchart of a method (1400) for coordinated spatial reuse and frequency utilization in an overlapping basic service set environment at a wireless device functioning as a station in a basic service set.

The method (1400) is performed by a wireless device functioning as a station (STA) in a basic service set (BSS). The STA receives (1402) a trigger frame from an access point (AP) within the same BSS. This trigger frame contains punctured bandwidth information, which is used for coordinating spatial reuse in an overlapping basic service set (OBSS) that overlaps with the current BSS. The punctured bandwidth information specifically identifies a portion of the bandwidth channel, referred to as the puncture portion, that should be excluded from use during the uplink data transmission.

After receiving the trigger frame, the STA proceeds to wirelessly transmit (1404) an uplink data packet to the AP within its BSS. The transmission of this uplink data packet is done using the punctured bandwidth channel, which is the channel specified in the trigger frame. However, the STA intentionally excludes at least a portion of the uplink data packet from being transmitted through the puncture portion of the channel. This means that the STA avoids using the puncture portion for transmitting its data, effectively creating a “hole” or “puncture” in the bandwidth channel.

The purpose of this selective transmission is to facilitate spatial reuse and minimize interference with the OBSS. By refraining from transmitting in the puncture portion of the bandwidth channel, the STA allows devices in the OBSS to utilize that specific portion for their own transmissions without interfering with the uplink data packet being sent by the STA in the BSS.

Overall, the method (1400) enables efficient coordination of spatial reuse between overlapping BSSs. The AP provides the necessary information through the trigger frame, and the STA follows the instructions to transmit its uplink data packet while excluding the puncture portion, thereby promoting coexistence and reducing interference between the BSSs.

In an embodiment, the method (1400) is extended by how the punctured bandwidth information is used by the wireless device functioning as a station (STA) in a basic service set (BSS).

In this extension, the punctured bandwidth information included in the trigger frame received from the access point (AP) specifically identifies a puncture subchannel within the punctured bandwidth channel. This puncture subchannel is designated as the puncture portion, which means it should be excluded from use during the uplink data transmission by the STA.

Upon receiving the trigger frame with the punctured bandwidth information, the STA proceeds to wirelessly transmit an uplink data packet to the AP within its BSS. The transmission of this uplink data packet is carried out using the punctured bandwidth channel, as specified in the trigger frame. However, the STA takes special care to exclude the puncture subchannel from the transmission.

In other words, when transmitting the uplink data packet, the STA uses the entire punctured bandwidth channel except for the specific subchannel identified as the puncture subchannel. This selective transmission ensures that no part of the uplink data packet is sent through the puncture subchannel, effectively creating a “hole” or “puncture” in the utilized bandwidth.

By excluding the puncture subchannel from the transmission, the STA allows devices in the overlapping basic service set (OBSS) to use that specific subchannel for their own communications without interfering with the uplink data packet being sent by the STA in the BSS. This coordinated spatial reuse mechanism helps to mitigate interference and promotes efficient utilization of the available bandwidth resources in overlapping wireless networks.

The extension highlights the granularity of the punctured bandwidth information, where a specific subchannel is identified as the puncture portion, enabling more precise control over the excluded bandwidth during the uplink data transmission.

In another extension of the method (1400), the punctured bandwidth information included in the trigger frame received from the access point (AP) identifies a specific resource unit, referred to as the puncture resource unit, within the punctured bandwidth channel. This puncture resource unit is designated as the puncture portion, indicating that it should be treated differently during the uplink data transmission by the STA.

When transmitting the uplink data packet to the AP, the STA divides the packet into two distinct portions: the preamble portion and the payload portion. The preamble portion of the uplink data packet contains important control information and is typically transmitted at the beginning of the packet to assist with synchronization, channel estimation, and other critical functions.

According to this extension, the STA transmits the preamble portion of the uplink data packet using the entire punctured bandwidth channel, including the puncture resource unit. This means that the preamble is sent across all the available resource units within the punctured bandwidth channel, ensuring that the necessary control information is conveyed to the AP.

However, when it comes to transmitting the payload portion of the uplink data packet, which contains the actual data being sent by the STA, the STA excludes the puncture resource unit from the transmission. This means that the payload is transmitted using the punctured bandwidth channel, but the specific resource unit identified as the puncture resource unit is not utilized for carrying the payload data.

By excluding the puncture resource unit from the payload transmission, the STA allows devices in the overlapping basic service set (OBSS) to use that specific resource unit for their own communications without interfering with the payload of the uplink data packet being sent by the STA in the BSS. This selective transmission approach enables efficient spatial reuse and minimizes interference between overlapping wireless networks.

This extension showcases the flexibility of the punctured bandwidth information, where a specific resource unit can be identified as the puncture portion, allowing for more granular control over the excluded bandwidth during different parts of the uplink data transmission.

FIG. 15 is a flowchart of a method (1500) for coordinated spatial reuse and frequency utilization in an overlapping basic service set environment at a wireless device functioning as a station in the overlapping basic service set that overlaps the basic service set referred to in the method (1400).

The method (1500) introduces additional steps performed by a wireless device functioning as a station (STA) in the overlapping basic service set (OBSS), building upon the method (1400).

In this method (1500), the STA in the OBSS also receives (1502) the trigger frame that was originally sent by the access point (AP) in the basic service set (BSS). This trigger frame contains punctured bandwidth information, which identifies a puncture portion of a punctured bandwidth channel, as described above with respect to method (1400).

Upon receiving the trigger frame, the STA in the OBSS proceeds to determine (1504) the maximum allowed transmit power based on spatial reuse power control information included in the trigger frame. This spatial reuse power control information provides guidelines or constraints on the transmit power that the STA in the OBSS should adhere to when transmitting its own uplink data.

The STA in the OBSS then wirelessly transmits (1506) at least a portion of its uplink data transmission to the AP within the OBSS. Importantly, this uplink data transmission from the STA in the OBSS utilizes the puncture portion of the punctured bandwidth channel, which was identified in the trigger frame.

By transmitting its uplink data through the puncture portion, the STA in the OBSS takes advantage of the unused bandwidth that was intentionally excluded by the STA in the BSS during its own uplink data transmission, as described above with respect to method (1400). This allows the STA in the OBSS to send its data without interfering with the uplink transmission from the STA in the BSS.

Furthermore, the STA in the OBSS transmits its uplink data at or below the maximum allowed transmit power, which was determined based on the spatial reuse power control information in the trigger frame. This ensures that the STA in the OBSS complies with any power constraints or limitations imposed by the AP in the BSS to facilitate efficient spatial reuse and minimize interference between the overlapping networks.

The method (1500) highlights the coordination and cooperation between the STAs in the BSS and OBSS to achieve effective spatial reuse. By leveraging the punctured bandwidth information and spatial reuse power control information provided in the trigger frame, the STAs can transmit their uplink data in a manner that optimizes the utilization of available bandwidth resources and reduces interference in overlapping wireless networks.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
at a wireless device functioning as an access point in a basic service set:
generating a trigger frame for triggering an uplink data transmission from a station in the BSS, wherein the trigger frame comprises punctured bandwidth information or good subchannel information for coordinating spatial reuse in an overlapping basic service set that overlaps the basic service set; and
wirelessly transmitting the trigger frame to trigger the uplink data transmission from the station and to coordinate spatial reuse in the overlapping basic service set.

2. The method of claim 1, wherein the trigger frame comprises punctured bandwidth information for coordinating spatial reuse in the overlapping basic service set, and wherein the punctured bandwidth information indicates a puncture subchannel that is to remain unused by the uplink data transmission from the station in the basic service set.

3. The method of claim 2, wherein the trigger frame indicates a width of the puncture subchannel as 20 MHz.

4. The method of claim 2, wherein the trigger frame comprises an indication to allow spatial reuse of the puncture subchannel in the overlapping basic service set.

5. The method of claim 2, wherein the punctured bandwidth information comprises spatial reuse power control information to calculate a maximum allowed transmit power for overlapping basic service set transmissions that use the puncture subchannel.

6. The method of claim 2, further comprising:
receiving the uplink data transmission via a portion of a punctured bandwidth channel that excludes the puncture subchannel.

7. The method of claim 1, wherein the trigger frame comprises punctured bandwidth information for coordinating spatial reuse in the overlapping basic service set, and wherein the punctured bandwidth information indicates a puncture resource unit that is to remain unused by a payload portion of the uplink data transmission from the station in the basic service set (BSS).

8. The method of claim 7, wherein a size of the puncture resource unit is less than 20 MHz.

9. The method of claim 7, wherein the trigger frame comprises an indication to allow spatial reuse of the puncture resource unit in the overlapping basic service set.

10. The method of claim 7, wherein the punctured bandwidth information comprises spatial reuse power control information to calculate a maximum allowed transmit power for overlapping basic service set data transmissions that use the puncture resource unit.

11. The method of claim 1, further comprising:
receiving a preamble portion of the uplink data transmission from the station in the basic service set via a punctured bandwidth channel that comprises the puncture resource unit; and
receiving a payload portion of the uplink data transmission via a portion of the punctured bandwidth channel that excludes the puncture resource unit.

12. The method of claim 1, wherein the trigger frame comprises good subchannel information for coordinating spatial reuse in the overlapping basic service set, and wherein the good subchannel information identifies a particular subchannel of a channel to be used for the uplink data transmission from the station in the basic service set.

13. The method of claim 12, wherein the spatial reuse trigger frame comprises spatial reuse power control information to calculate a maximum allowed transmit power for the uplink data transmission from the station in the overlapping basic service set via the particular subchannel.

14. The method of claim 12, further comprising:
at a wireless device functioning as an access point in the overlapping basic service set:
receiving the trigger frame;
generating a spatial reuse trigger frame for triggering an uplink data transmission from a station in the overlapping basic service set, wherein the spatial reuse trigger frame indicates the particular subchannel; and
wirelessly transmitting the spatial reuse trigger frame to trigger the uplink data transmission from the station in the overlapping basic service set via the particular subchannel.

15. A method comprising:
at a wireless device functioning as a station (ST) in a basic service set (BSS):
receiving a trigger frame from an access point in the BSS, wherein the trigger frame comprises punctured bandwidth information for coordinating spatial reuse in an overlapping basic service set (OBSS) that overlaps the BSS, wherein the punctured bandwidth information identifies a puncture portion of a punctured bandwidth channel; and
wirelessly transmitting an uplink data packet to the access point in the BSS via the punctured bandwidth channel excluding at least a portion of the uplink data packet from transmission via the puncture portion.

16. The method of claim 15, wherein the punctured bandwidth information identifies a puncture subchannel of the punctured bandwidth channel as the puncture portion, and wherein the uplink data packet is transmitted via the punctured bandwidth channel excluding the puncture subchannel.

17. The method of claim 15, wherein the punctured bandwidth information identifies a puncture resource unit as the puncture portion, wherein a preamble portion of the uplink data packet is transmitted via the punctured bandwidth channel including via the puncture resource unit, and wherein a payload portion of the uplink data packet is transmitted via the punctured bandwidth channel excluding the puncture resource unit.

18. The method of claim 15, further comprising:
at a wireless device functioning as a station (ST) in the overlapping basic service set (OBSS):
receiving the trigger frame;
determining a maximum allowed transmit power based on spatial reuse power control information in the trigger frame; and
wirelessly transmitting at least a portion of an uplink data transmission via the puncture portion of the punctured bandwidth channel to an access point in the OBSS at the maximum allowed transmit power.

19. A wireless device to function as an access point (AP) in a basic service set (BSS), the wireless device comprising:
a radio frequency transceiver;
a memory device storing a set of instructions; and
a processor coupled to the memory device, wherein the set of instructions when executed by the processor causes the AP in the BSS to perform:
generating a trigger frame for triggering an uplink data transmission from a station in the BSS, wherein the trigger frame comprises punctured bandwidth information or good subchannel information for coordinating spatial reuse in an overlapping basic service set (OBSS) that overlaps the BSS; and
wirelessly transmitting the trigger frame to trigger the uplink data transmission from the station and to coordinate spatial reuse in the OBSS.

20. A wireless device to function as a station (ST) in a basic service set (BSS), the wireless device comprising:
a radio frequency transceiver;
a memory device storing a set of instructions; and
a processor coupled to the memory device, wherein the set of instructions when executed by the processor causes the ST in the BSS to perform:
receiving a trigger frame from an access point in the basic service set, wherein the trigger frame comprises punctured bandwidth information for coordinating spatial reuse in an overlapping basic service set (OBSS) that overlaps the BSS, wherein the punctured bandwidth information identifies a puncture portion of a punctured bandwidth channel; and
wirelessly transmitting an uplink data packet to the access point in the basic service set via the punctured bandwidth channel excluding at least a portion of the uplink data packet from transmission via the puncture portion.
